(19) United States
(12) Patent Application Publication
(10) Pub. No.: US 2003/0144384 A1
(43) Pub. Date: Jul. 31, 2003

(54) Superplasticizer for concrete and self-leveling compounds

(76) Inventors: Fu Chen, West Chester, PA (US); Sung G. Chu, Hockessin, DE (US); Natalie A. Kolson, Wester Chester, PA (US)

Correspondence Address: HERCULES INCORPORATED, HERCULES PLAZA, 1313 NORTH MARKET STREET, WILMINGTON, DE, 19894-0001, US

(21) Appl. No.: 09/976,658

(22) Filed: Oct. 9, 2001

(51) Int. Cl. C08L 1/00

(52) U.S. Cl. 524/2

(57) ABSTRACT

A building material is composed of a co- or ter-polymer of (i) a material selected from carboxylic acid, sulfonic acid, phosphonic acid, a amide form thereof or mixtures thereof and (ii) at least one polyethylene glycol monoallyl ether sulfate and a binding material of cement or gypsum. This building material can be used throughout the construction industry in many applications because the superplasticizer provides improved fluidity and yet is economical and efficient.

### FIELD OF INVENTION

The present invention relates to the use of superplasticizing additives for concrete and other cementitious materials that substantially increase the initial workability of the cementitious mixes, to maintain the workability for longer periods than those corresponding to the traditional superplasticizers, and to allow an easy placing of the cementitious materials. More specifically, this invention relates to the use of a co- or ter-polymer of a carboxylic acid, sulfonic acid, or phosphonic acid and polyethyleneglycol monoallyl ester sulfate in cementitious building materials as a superplasticizer that achieves the above properties as well as has no adverse effect on the mechanical properties of the materials.

### BACKGROUND OF THE INVENTION

The construction industry uses various superplasticizers for producing strong concrete and other cementitious materials (e.g., self-leveling compounds, self-compacting concrete, anhydrite floor screeds, etc). Polyacrylate superplasticizers are the premium products for producing high compressive strength concrete with longer workability. Polyacrylate superplasticizers are more effective products than conventional superplasticizers, such as naphthalene, lignin, and melamine sulfonates, since they have less slump loss (better pumpability/workability for 90 minutes), low air entraining effect, and higher water reducing capacity. They also do not contain formaldehyde, which is a hazardous material.

Prior art on polyacrylate superplasticizers for concrete applications have been developed capable to maintain the same fluidity for longer periods and allow the transport of fresh concrete for long distances without further retempering the concrete at the placing-site. These new additives are based on crosslinked hydrophilic acrylic polymers, which hydrolyze in the strong alkaline medium of cementitious mixes to produce linear polymer chains, which reduce the slump loss effect.

U.S. Pat. No. 5,362,324 (Cerulli et al) describes terpolymers of (meth)acrylic acid and polyethyleneglycol-monomethylether-(meth)acrylate and polypropyleneglycoldi (meth)acrylate for superplasticizer applications. U.S. Pat. No. 5,661,206 (Tanaka et al) and EP 448 717 B1 (Nippon Shokubai Co. Ltd.) disclose similar technology to that of Cerulli et al using diepoxy based crosslinking agent. Takemoto Oil & Fat Co., also patented in Japan (JP 22675, and 212152) acrylic acid terpolymers with sodium methallylsulfonate and methoxy polyethylene glycol-monomethacrylate for superplasticizer applications.

U.S. Pat. No. 6,139,623 (Darwin et al) discloses an admixture composition containing emulsified comb polymer and defoaming agent for use as a concrete superplasticizer. The comb polymer described in this patent has a carbon-containing backbone to which are attached cement-anchoring molecules (acrylic acid) and oxyalkylene groups. The oxyalkylene groups were obtained from Jaffamine M-2070, which is a copolymer of polyethylene-propylene oxide with primary amine and methyl group as the terminal groups.

U.S. Pat. No. 5,858,083 (Stav et al) discloses composition of self-leveling flow compound composition containing naphthalene sulfonate and/or lignin sulfonate as dispersant and beta-gypsum stucco and Portland cement as binder.

WO 99/08978 (Yu et al) disclose the composition of gypsum wall board formulation containing dispersants such as naphthalene sulfonate and or lignin sulfonate.

None of the above prior art discloses the instant invention; there still remains a need in the art for a superplasticizer that has improved fluidity and yet is economical and efficient.

### SUMMARY OF THE INVENTION

The present invention is directed to a building material composition comprising:

a) a co- or ter-polymer of (I) a material selected from the group consisting of carboxylic acid, sulfonic acid, phosphonic acid, amide form thereof or mixtures thereof and (ii) at least one polyethyleneglycol monoalkyl ether sulfate and

b) a binding material selected from the group consisting of gypsum and cement.

This invention is also related to a method for producing a fluidity controlling building material comprising polymerizing a monomer mixture of a co- or ter-polymer of a carboxylic acid, sulfonic acid, or phosphonic acid or amide form thereof or mixtures thereof and polyethyleneglycol monoallyl ester sulfate for a sufficient time and temperature for producing a polymer of the monomers and adding the polymer to a cementitious mixture of ingredients to produce the fluidity controlling building material.

### DETAILED DESCRIPTION OF THE INVENTION

It has been surprisingly found that it is possible to make a building material that has a high slump but without excessive aeration by using a superplasticizer of a co- or ter-polymer of a carboxylic acid, sulfonic acid, or phosphonic acid that includes a polyethyleneglycol monoallyl ester sulfate monomer.

Superplasticizer

The present invention pertains to the use of novel water-soluble or water-dispersible polymers, which contain pendant functional groups as additives for concrete and other cementitious materials. The polymers of the present invention are copolymers or terpolymers having the structure of Formula I.

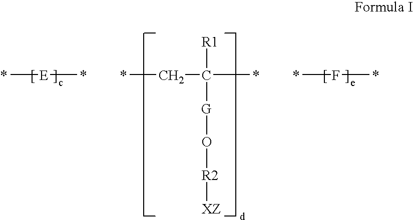

wherein E is the repeat unit remaining after polymerization of an ethylenically unsaturated compound; preferably, a carboxylic acid, sulfonic acid, phosphonic acid, or amide form thereof or mixtures thereof. R₁ is H or lower (C₁-C₄) alkyl. G is —CH₂— or —CHCH₃—; R₂ is (CH₂—CH₂—O)ₙ or (CH₂—CHCH₃—O)ₙ where n is an integer that ranges from about 1 to 100, preferably about 1 to 20.

X is an anionic radical selected from the group consisting of SO₃, PO₃, or COO;

Z is hydrogen or any water soluble cationic moiety which counterbalances the valence of the anionic radical X, including but not limited to Na, K, Ca, or NH₄.

F, when present, is a repeat unit having the structure of Formula II.

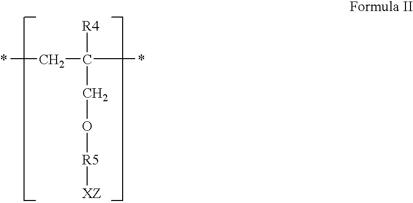

In Formula II, X and Z are the same as in Formula I. R4 is H or lower (C₁-C₄) alkyl. R₅ is hydroxy substituted alkyl or alkylene having from about 1 to 6 carbon atoms.

With respect to E of Formula 1, it may comprise the repeating unit obtained after polymerization of a carboxylic acid, sulfonic acid, phosphonic acid, or amide form thereof or mixtures thereof. Exemplary compounds include, but are not limited to, the repeating unit remaining after polymerization of acrylic acid, methacrylic acid, acrylamide, methacrylamide, N-methyl acrylamide, N,N-dimethyl acrylamide, N-isopropylacrylamide, maleic acid or anhydride, fumaric acid, itaconic acid, styrene sulfonic acid, vinyl sulfonic acid, isopropenyl phosphonic acid, vinyl phosphonic acid, vinylidene di-phosphonic acid, 2-acrylamido-2-methylpropane sulfonic acid and the like and mixtures thereof. Water-soluble salt forms of these acids are also within the purview of the present invention. More than one type of monomer unit E may be present in the polymer of the present invention.

Subscripts c, d, and e in Formula I are the molar ratio of the monomer repeating unit. The ratio is not critical to the present invention providing that the resulting copolymer is water-soluble or water-dispersible. Subscripts c and d are positive integers while subscript e is a non-negative integer. That is, c and d are integers of 1 or more while e can be 0, 1, 2, etc.

A preferred copolymer of the present invention, that is where e=0, is acrylic acid/polyethyleneglycol monoallyl ether sulfate of the structure of Formula III.

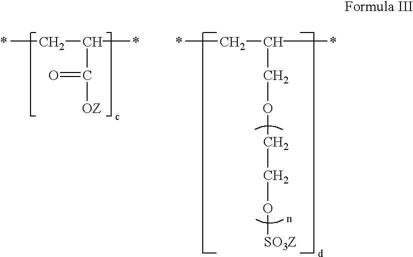

Wherein n ranges from about 1 to 100, preferably about 1 to 20. Z is hydrogen or a water-soluble cation such as Na, K, Ca or NH₄.

Molar ratio c:d ranges from 30:1 to 1:20. Preferably, the molar ratio of c:d ranges from about 15:1 to 1:10. The ratio of c to d is not critical to the present invention providing that the resulting polymer is water-soluble or water-dispersible.

A preferred terpolymer of the present invention, that is where e is a positive integer, is acrylic acid/polyethyleneglycol monoallyl ether sulfate/1-allyloxy-2-hydroxypropyl-3-sulfonic acid of the structure of Formula IV.

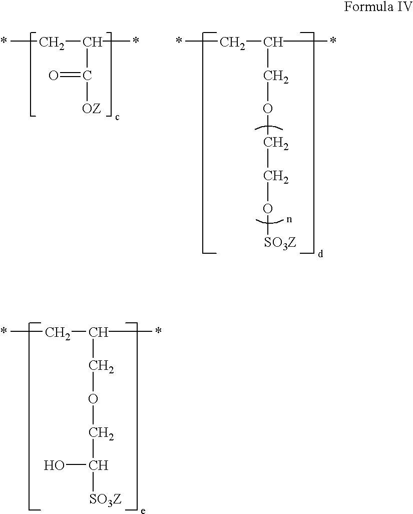

Wherein n ranges from about 1-100, preferably about 1-20. Z is hydrogen or a water-soluble cation such as, Na, K, Ca or NH₄. Z may be the same or different in c, d and e. The mole ratio of c:d:e is not critical so long as the terpolymer is water-soluble or water-dispersible. Preferably the mole ratio c:d:e ranges from about 20:10:1 to 1:1:20.

The polymerization of the copolymer and/or terpolymer of the present invention may proceed in accordance with solution, emulsion, micelle or dispersion polymerization techniques. Conventional polymerization initiators such as persulfates, peroxides, and azo type initiators may be used. Polymerization may also be initiated by radiation or ultraviolet mechanisms. Chain transfer agents such as isopropanol, allyl alcohol, hypophosphites, amines or mercapto compounds may be used to regulate the molecular weight of the polymer. Branching agents such as methylene bisacrylamide, or polyethylene glycol diacrylate and other multifunctional crosslinking agents may be added. The resulting polymer may be isolated by precipitation or other well-known techniques. If polymerization is in an aqueous solution, the polymer may simply be used in the aqueous solution form.

The weight average molecular weight (Mw) of the water-soluble copolymer of Formula I is not critical but preferably falls within the range Mw lower limit of about 1,000 Daltons and upper limit of about 1,000,000 Daltons. More preferably, the upper limit is about 50,000 Daltons and the lower limit is about 1,500 Daltons. Even more preferably, and the upper limit is about 25,000 Daltons. The essential criterion is that the polymer be water-soluble or water-dispersible.

Building Materials

By “building material” reference is made to members of the class of construction materials exemplified by concrete, tile cements and adhesives, projection plasters, stuccos based on cement and synthetic binders, ready mixed mortars, manually applied mortars, underwater concrete, joint cement, crack fillers, floor screeds, and adhesive mortars. These materials are essentially Portland cements, Plaster of Paris or vinyl copolymers containing functional additives to impart characteristics required for various construction applications. Controlling the water ratio, i.e., the point at which optimum application properties are obtained, in these materials is therefore of great importance.

Lime was one of the preferred materials for controlling the water ratio in building materials. Today non-ionic cellulose ethers have been given this role, as they improve water retention characteristics and other physical properties such as workability, consistency, open time, tack, bleeding, adhesion, set time, and air entrainment.

In accordance with the present invention, the superplasticizer that is a co- or ter-polymer of ethylenically unsaturated monomers and a polyethyleneglycol monoallyl ester sulfate imparts excellent workability, consistency, appearance, and air content, as well as adhesion to building materials while reducing water demand.

The building material composition of the present invention includes, based on the total solids phase of the dry composition, from about 2 to about 99 wt % of at least one hydraulic or synthetic binder, up to about 95 wt. % of at least one filler, and from about 0.05 to about 5 wt. % of at least one of the superplasticizers of the present invention. They may be used alone or in combination with cellulose ethers, naphthalene sulfonate and/or lignin sulfonate as building material additives.

### EXAMPLE 1

### Preparation of Acrylic Acid/Ammonium Allylpolyethoxy (10) Sulfate Copolymer

A suitable reaction flask was equipped with a mechanical agitator, a thermometer, a reflux condenser, a nitrogen inlet and two addition inlets for the initiator and monomer solutions. The flask was charged with 73.5 g of deionized water and 58.5 g (0.1 mol) of ammonium allyl polyethoxy(10) sulfate. While sparging with nitrogen, the solution was heated to 85° C. An initiator solution containing 2.2 g. of 2,2′-azobis(2-amidinopropane)hydrochloride (Wako V-50, from Wako Chemical Company) was sparged with nitrogen for ten minutes. The initiator solution and 21.6 g. (0.3 mol) of acrylic acid were added gradually to the reaction flask over a three-hour period. Following the addition, the solution was heated to 95° C. and held for 60 minutes. The reaction was then cooled to lower than 60° C. and 50% caustic solution was added until the pH measured 8-9. The reaction was heated to 95° C. for one hour to remove ammonia.

### EXAMPLE 2

### Preparation of Acrylic Acid/Ammonium Allylpolyethoxy (10) Sulfate Copolymer

Utilizing the apparatus as described in Example 1, a reaction flask was charged with 73.5 g of deionized water and 58.5 g (0.1 mol) of ammonium allyl polyethoxy(10) sulfate. While sparging with nitrogen, the solution was heated to 85° C. An initiator solution containing 1.9 g. of sodium persulfate in Dl water was sparged with nitrogen for ten minutes. The initiator solution and 21.6 g. (0.3 mol) of acrylic acid were added gradually to the reaction flask over a two hour period. A solution containing 0.88 g. of sodium hypophosphite in 5 g. of water was also added to the flask over a 90 minute period. Following the addition, the solution was heated to 95° C. and held for 60 minutes. The reaction was then cooled to lower than 60° C. and 50% caustic solution was added until the pH measured 8-9. The reaction was heated to 95° C. for one hour to remove ammonia.

### EXAMPLES 3-10

Additional copolymers were prepared in accordance with the general procedure as described in Examples 1 and 2 with varying co-monomer mole ratios of the monomers and molecular weights.

Table 1 summarizes the compositions and physical properties of the co- and ter-polymers of Examples 1 to 10. The molecular weights were obtained by a Size Exclusion Chromatography analysis using polyacrylic acid as standard.

TABLE 1

| | Polymer | | | | |
|---|---|---|---|---|---|
| | Composition | | | | |
| | (monomer | % Solids | Viscosity | | |
| Example | mole ratio) | (% Actives) | sp1 @ 60 | pH | Mw |
| 1 | AA/APES (3/1) | 25.5 | 19.0 cps | 6.1 | 15.300 |
| 2 | AA/APES (4/1) | 26.0 | 12.0 cps | 5.6 | 5.960 |
| 3 | AA/APES (6/1) | 25.1 | 12.0 cps | 5.6 | 6.450 |
| 4 | AA/APES (3/1) | 26.9 | 23.0 cps | 6.0 | 33.500 |
| 5 | AA/APES (3/1) | 24.6 | 43.0 cps | 5.7 | 69.800 |
| 6 | AA/APES (3/1) | 24.8 | 13.0 cps | 5.9 | 10.100 |
| 7 | AA/APES (3/1/) | 21.7 | 13.8 cps | 8.5 | 17.900 |
| 8 | AA/APES/AHPS | 21.58 | 13.0 cps | 8.6 | 15.400 |
| | (6/1/1) | | | | |
| 9 | AA/APES (3/1) | 37.4 | 80.5 cps | 6.0 | 19.600 |
| 10 | AA/APES (3/1) | 25.2 | 15.9 cps | 6.0 | 16.700 |

AA = acrylic acid
APES = ammonium allylpolyethoxy (10) sulphate, with 10 moles of ethylene oxide, DVP-010, from Bimax Inc.
AHPS = 1-allyloxy-2-hydroxypropyl-3-sulfonic acid, from BetzDearborn

### EXAMPLE 11

### Evaluation for Self Leveling Property

A self-leveling flow test was run for the blends of Portland cement/sand and water with various superplasticizers. Commercial superplasticizers: Mapefluid® X404 polyacrylate from Mapei Co., Japan, Malialim® polyacrylate from Nopco, Japan; Lomar® D naphthalene sulfonate from GEO Chemical Co. and AA/AHPS and AA/AE-10 polyacrylate dispersant from BetzDearbom Division of Hercules Incorporated, Wilmington, Del., were used as control samples. From this flow measurement, the samples' dispersing power, water reducing capacity, and flow stability after aging 90 minutes were compared.

It was found that the copolymers of the invention, showed excellent superplasticizing effect on mortar cement formulations and other cementitious mixes. The copolymers reduced the water demand of the cement mix and generated good initial flow, and maintained retention of workability.

The preliminary evaluation data of Portland cement/sand and additive mixes are shown in Tables 2-4 and flow evaluation method is described after Table 4.

TABLE 2
FLOW PROPERTY OF CEMENT/SAND WITH
VARIOUS SUPERPLASTICIZERS
Flow of cement/sand with various superplasticizers
0.15 wt % superplasticizer based on cement

| | | Initial flow | Flow after 90 minutes |
|---|---|---|---|
| Example | W/C ratio | (inches) | (inches) |
| No Additives | 0.54 | 2.75 | 0 |
| AA/AHPS | 0.48 | 3.25 | 0 |
| AA/AE-10 | 0.48 | 2.5 | 0 |
| AA/AHPS/AE-10 | 0.48 | 2.75 | 0 |
| 1 | 0.48 | >5 | 0 |
| 1 | 0.52 | >5 | 4.4 |
| 2 | 0.48 | >5 | 0 |
| 2 | 0.52 | >5 | 3.75 |
| 3 | 0.48 | >5 | 0 |
| 3 | 0.52 | >5 | 3.25 |

* AA/AHPS is acrylic acid/allyl hydroxypropyl sulfonate ether copolymer, Mw about 15,000.
** AA/AE-10 is acrylic acid/polyethyleneglycol (10 moles of ethyleneoxide) allyl ether, Mw about 30,000
*** AA/AHPS/AE-10 is acrylic acid/allyl hydroxypropyl sulfonate ether/polyethyleneglycol (10 moles of ethyleneoxide) allyl ether, Mw about 25,000.

TABLE 3
Effect of concentration of flow property of superplasticizer
Flow data of the blend of Portland cement and sand (½) with
various amounts of superplasticizer
50 grams P.C., 100 grams sand, 20 grams D. water (W/C = 0.4)

| Example 1 (%) | Initial flow |
|---|---|
| Based on Cement | (inches) |
| 0.05 | 0 |
| 0.10 | 2.5 |
| 0.15 | 3.8 |
| 0.20 | 4.8 |

TABLE 4
Flow property of cement/sand with various superplasticizers
Flow data of the blend of Portland cement
and sand (½) with various superplasticizers

| Wt % | | Water/cement | Initial flow | Flow after 90 |
|---|---|---|---|---|
| Superplasticizer | | ratio | (inches) | minutes (inches) |
| Example 1 | 0.15% | 0.44 | >5 | |
| Example 1 | 0.15% | 0.40 | 3.25 | 0 |
| Example 1 | 0.15% | 0.52 | >5 | 4.4 |
| Mapei fluid | 0.15% | 0.44 | 3.5 | 0 |
| Mapei fluid | 0.15% | 0.52 | >5 | >5 |
| Control | 0% | 0.52 | NM | 0 |

### Cement Slurry Spreadability (Self-Leveling) Evaluation Method

1. 20 grams of deionized water (W/C=0.4) were added into a 250 ml glass cup.

2. 50-grams of cement were charged to the glass cup over 10 seconds and the cement in the water was stirred for one minute.

3. The mixture was allowed to stand for one minute to form a cement paste.

4. The cement paste was stirred with a spatula vigorously for 10 seconds.

5. The cement paste was poured onto a 5″×5″ glass plate through a funnel which was positioned at a 3-inch height above the 5″×5″-glass plate; the cake diameter size on the glass plate was then measured.

6. If the cake diameter size was smaller than 3 inches, the experiment was repeated with additional water until the diameter of the cake was about 3 inches.

7. The initial and final set times were measured with Gillmore needles and recorded in a laboratory notebook. This was the control data.

8. The above experiment was repeated with 20 g of water and the polymer solution of this invention.

### EXAMPLE 12

### Evaluation of Cement Mortars with Various Superplasticizers

A cement mortar flow test with a flow table according to ASTM C230 was run and the density (ASTM C185/C91) and set time (ASTM C266) of the cement mortars were measured based on samples of commercial products and experimental polymers of the present invention. These data are related to slump loss, workability, and water reducing capacity of the superplasticizer for concrete applications. Commercial materials including Lomar® D, Advacast® D, and PS1232 products were used as comparison. The results are shown in Tables 5 and 6.

TABLE 5
Cement mortar properties with various plasticizers
Mortar properties of the blend of Portland cement and Ottawa sand (1/2.75)
with various superplasticizers at water cement ratio = 0.4 (ASTM C-230)

| | Wt % | | | | Initial | Final | | Compressive |
|---|---|---|---|---|---|---|---|---|
| | Superplasticizer | Initial flow | Flow after | Flow after | Set time | Set time | Air content | Strength* |
| Example | BOC | (inches) | 60 minutes | 90 minutes | (minutes) | (minutes) | (%) | (7 days) |
| Example 1 | 0.15% | 117 | 89.3 | 83 | 120 | 210 | 14.4 | 5871 |
| Lomar D | 0.5% | 98 | 59 | — | 70 | — | 9.3 | 5760 |
| AA/AHPS | 0.15% | 62.5 | — | — | 75 | — | 8.9 | 5118 |
| AA/AE-10 | 0.15% | 80 | 69 | — | 85 | 150 | 11.3 | 5593 |
| Malialim | 0.15% | 98 | 92.3 | 91.8 | 110 | 171 | 11.9 | 6409 |
| EKM60F | | | | | | | | |
| Mapefluid | 0.15% | 95.5 | 87.5 | 76.2 | 85 | 185 | 10.1 | 7383 |
| X404 | | | | | | | | |
| Advacast* | 0.25% | 98 | — | 71.5 | — | 200 | 5.9 | 6573 |
| PS1232** | 0.15% | 97 | — | 87 | — | 210 | 12.3 | 5843 |

*Advacast is a polyacrylate from WR Grace;
**PS1232 is a polyacrylate from Master Builder

Set time measurement was measured on a Gillmore needle penetrometer (ASTM C-403).

Air content of wet mortars was measured by volume and weight measurement (ASTM C185/C91) and compressive strength was measured following ASTM C-87.

### EXAMPLE 13

### Evaluation of New Polymers as Superplasticizer for Concrete

The slump property, density, and compressive strength of concrete samples were measured using various superplasticizers. The following concrete formulation (Table 6) was mixed in a 5-gallon lab. mixer for 10 minutes and a slump test was run according to ASTM C143. Slump data after 90 minutes was obtained from the concrete, which was mixed for 10 minutes, rested for 75 minutes and again mixed for 5 minutes before measuring its slump value. Compressive strength of the 1 0-inch cylinder was measured according to ASTM C-39 after drying for 7 days.

TABLE 6
Concrete formulation with 0.15 wt % Superplasticizer

| | Weight | Concen- | |
|---|---|---|---|
| | (g) | tration (%) | Comments |
| Portland Cement 1 | 2940 | 16.3 | Water/cement = 0.4 |
| Saturated sand | 5556 | 30.7 | Aggregate/cement = 4.74 |
| Gravel (¾ inch) | 8390 | 46.4 | |
| Water | 1170 | 6.5 | |
| Example 10 | 17.6 | 0.1 | (0.15% based on cement) |
| Total | 18073.6 | 100 | |

The evaluation data is summarized in Table 7. As expected from the mortar data, the copolymers of the invention as the sodium or calcium salt worked well in the slump test. Their initial densities are comparable to the densities of the commercial samples. This density data indicates that the copolymer does not generate excessive air in a low-speed concrete mixing process.

TABLE 7
Slump and Compressive Strength of Concrete with various Plasticizers
(Water/Cement = 0.4, Cement/Sand/Aggregate = 294/555/839)

| | | | 90 minutes | 7 days dry | 7 days |
|---|---|---|---|---|---|
| | Polymer | Initial slump | slump | density | Compressive |
| Example | conc. (%) | (inches) | (inches) | (g/cm3) | strength (psi) |
| Example 1 | 0.13 | 8.25 | — | 2.38 | 3154 |
| Ca salt of −1 | 0.15 | 8.75 | 5.5 | 2.39 | 3200 |
| AA/AHPS | 0.20 | 4.75 | — | 2.47 | 3250 |
| ADVA Cast | 0.18 | 9.5 | — | 2.40 | 3587 |
| ADVA Cast | 0.15 | 5.5 | 2 | — | — |
| PS 1232 | 0.15 | 8.25 | 7.5 | 2.36 | 3417 |

* Normalized data from 0.18% data

### EXAMPLE 14

### Evaluation of New Polymers as Superplasticizers for Concrete Application

The concrete formulation in Table 8 was mixed in a six cubic feet commercial concrete mixer for 5 minutes. The slump properties, air contents, set time and compressive strength of the concrete samples with various superplasticizers is summarized in Table 9. Slump retention data was obtained after 30 minutes of mixing. Compressive strength of the 30 inch cylinder was measured according to ASTM C39 after drying for 7 days (Table 10). The concrete samples with various superplasticizers were filtered with a metal screen to obtain cement-sand slurry for measuring the set time. Set time of cement slurry was measured according to ASTM C403. Daracem® product is a naphthalene sulfonate marketed by W. R. Grace.

TABLE 8
Concrete formulation (water/cement ratio = 0.4)

| Ingredients | Wt (lb) | Wt % |
|---|---|---|
| Portland Cement I | 144.4 | 16.3 |
| Sand | 272.4 | 30.8 |
| Gravel (<¾ inch) | 411.6 | 46.4 |
| Water | 52.7 | 6.5 |
| Total | 885.6 | 100 |
| Superplasticzer | 4-6 oz/cwt | 0.04-0.06 wt % of cement |

TABLE 9
Performance of concretes with various superplasticizers

| Sample | Control | Ex. 7 | Ex. 8 | PS1232 | Darachem |
|---|---|---|---|---|---|
| Addition, (oz/cwt) | 0 | 4 | 6 | 4 | 12 |
| Slump, inch | 1.75 | 6.5 | 6.25 | 6.5 | 8.75 |
| Initial Setting time | 4:20 | 5:01 | 4:29 | 4:27 | 4:51 |
| Final Setting time | 6:08 | 7:26 | 6:23 | 6:32 | 6:43 |
| 7 days cured Compressive strength (psi) | 2600 | 2750 | NM* | 2777 | NM* |
| 28 days cured Compressive strength (psi) | | | | | |

TABLE 10
Slump retention data of concrete with various superplasticizers

| Example | Control | Example 7 | Advaflow | PS1232 |
|---|---|---|---|---|
| Addition, (oz/cwt) | 0 | 6 | 4 | 6 |
| Initial Slump inch | 2.75 | 8 | 7.5 | 8.75 |
| Slump after 30 mins Inch | — | 5.75 | 5.25 | 6.5 |
| Initial Air Content (%) | 5.5 | 8.9 | 11.5 | 9.2 |
| Air after 30 mins mixing (%) | — | 13 | 13 | 17 |

### EXAMPLE 15

Evaluation of the polymer for self-leveling compound was carried out with the following basic mixture. The composition is shown in Table 11. The copolymer of the invention and the commercial superplasticizer Melflux 1641 F, from SKW were evaluated for flowability, self healing, density, strength value, pot life and setting behavior; these properties are summarized in Table 12.

TABLE 11
Composition of self leveling compound basic mix.

| Ingredient | Wt (%) |
|---|---|
| Portland cement | 18.5 |
| Calcium Alumina cement | 11.5 |
| Calcium sulfate | 6.5 |
| Quartz sand | 41 |
| Limestone powder | 19.40 |
| Redispersible PVA powder | 2.0 |
| Retarder (K-Na tatrate) | 0.4 |
| Accelerator | 0.1 |
| Defoamer | 0.15 |
| Stabilizer (Cellulose ether) | 0.05 |
| Natrosol 250GXR | |
| Total | 100 |

TABLE 12
Physical properties of self-leveling compounds with various
superplasticzers

| | | B | | |
|---|---|---|---|---|
| | A | 0.3 wt % | C | D |
| Properties | 0.3 wt % | Melflux | 0.1 wt % | 0.2 wt % |
| Superplasticizer* | Example 9 | 1641 | Example 9 | Melflux 1641F |
| Water ratio | 0.22 | 0.22 | 0.18 | 0.18 |
| Spreading value | 190 | 195 | 199 | 200 |
| Knife cut** | 1, 1, 2, 6 | 1, 1, 1, 2 | 1, 1, 2, 3, 3 | 1, 2, 2, 3, 7 |
| Density | — | — | 2.05 | 2.05 |
| Flex strength | — | — | 2.2 | 2.4 |
| 1 day(N/mm²) | | | | |
| Flex strength | — | — | 4.4 | 3.7 |
| 7 days (N/mm² ) | | | | |
| Compressive | — | — | 7.4 | 7.7 |
| strength, | | | | |
| 1 day (N/mm²) | | | | |
| Compressive | — | — | 13.4 | 13.1 |
| Strength, 7 days | | | | |
| (N/mm²) | | | | |
| Pot life(min) | — | — | 60 | 53 |

*superplasticzer wt % based on basic mix.
**Knife-cuts were conducted every 10 minutes.
1; cut heals, completely, invisible
2; cut heals, but visible
3; cut heals, but visible edges
4; cut heals, but well visible edges
5; cut heals but visible scar
6; cut heals. but well visible scar
7; cut does not heal

### EXAMPLE 16

The copolymer of the invention and a commercial product, Lomar® D, were evaluated as superplasticizers for gypsum wall board application. The gypsum wall board formulation in Table 13 was mixed in a 1 gallon Hobart mixer and casted into one foot square (½ inch thickness) paper envelop in a vertical mold. The solidified wallboard sample was dried in the oven at 375° F. and 250° F. The gypsum wall board properties were summarized in Table 13.

TABLE 13
Gypsum wallboard formulations with
two different superplasticizers

| | Control sample | | Example | |
|---|---|---|---|---|
| Gypsum stucco | 1000 | grams | 1000 | grams |
| (Hemihydrate) | | | | |
| Dispersant | 2.3 | grams | 1.2 | grams |
| | Napthalene | | Example 7 | |
| | sulfonate | | | |
| Retarder | 0.8 | grams | 0 | |
| (Polyacrylic acid) | (0.008 wt % based | | | |
| | on gypsum) | | | |
| Accelerator | 1.40 | grams | 1.40 | grams |
| Oxidized Starch | 5 | grams | 5 | grams |
| Water | 492 | grams | 492 | grams |
| Foaming agent | 10 | grams | 10 | grams |
| (5% in water) | | | | |
| Foam volume | 1260 | ml | 1260 | ml |
| Total water | 830 | ml | 830 | ml |
| ¼ Gill set time | 4.75 | minutes | 5.5 | minutes |
| Board density | 0.60 | g/cm³ | 0.608 | g/cm³ |
| (dry) | | | | |

| | | |
|---|---|---|
| Nail pull strength (BF) | 56.5 | 59.6 |
| Compressive strength (psi) | 199 +/− 8 | 204 +/− 7 |
| Paper adhesion | Good | Good |

While this invention has been described with respect to specific embodiments, it should be understood that these embodiments are not intended to be limiting and that many variations and modifications can be made without departing from the spirit and scope of the invention, and therefore, only such limitations should be imposed as are indicated by the appended claims.

What is claimed is:

1. A building material composition comprising
a) a co- or ter-polymer of (i) a material selected from the group consisting of carboxylic acid, sulfonic acid, phosphonic acid, amide form thereof or mixtures thereof and (ii) at least one polyethyleneglycol monoallyl ether sulfate and
b) a binding material comprised of cement or gypsum.

2. The building material composition of claim 1, wherein the binding material is Portland cement.

3. The building material composition of claim 2, wherein the cement is selected from the group consisting of concrete, tile cements and adhesives, projection plasters, stuccos based on cement and synthetic binders, ready mixed mortars, manually applied mortars, underwater concrete, joint cement, crack fillers, floor screeds, and adhesive mortars.

4. The building material composition of claim 1, wherein the gypsum is plaster of Paris.

5. The building material of claim 1, wherein the material of a)i) is selected from the group consisting of acrylic acid, methacrylic acid, acrylamide, methacrylamide, N-methyl acrylamide, N,N-dimethyl acrylamide, N-isopropylacrylamide, maleic acid or anhydride, fumaric acid, itaconic acid, styrene, sulfonic acid, vinyl sulfonic acid, isopropenyl phosphonic acid, vinyl phosphonic acid, vinylidene di-phosphonic acid, 2-acrylamido-2-methylpropane sulfonic acid and mixtures thereof.

6. The building material of claim 1, wherein the weight average molecular weight (Mw) of the co- or ter-polymer has a lower limit of 1000 Daltons.

7. The building material of claim 1, wherein the weight average molecular weight (Mw) of the co- or ter-polymer has a lower limit of 1500 Daltons.

8. The building material of claim 1, wherein the weight average molecular weight (Mw) of the Co- or ter-polymer has an upper limit of 1,000,000 Daltons.

9. The building material of claim 1, wherein the weight average molecular weight (Mw) of the co- or ter-polymer has an upper limit of 50,000 Daltons.

10. The building material of claim 1, wherein the weight average molecular weight (Mw) of the co- or ter-polymer has an upper limit of 25,000 Daltons.

11. The building material composition of claim 1, wherein a) (i) is acrylic acid.

12. The building material composition of claim 1 1, wherein a) (ii) is ammonium allylpolyethoxy (10) sulphate.

13. The building material composition of claim 12, wherein a) (ii) also includes 1-allyloxy-2-hydroxypropyl-3-sulfonic acid.

14. The building material composition of claim 1, wherein a) (i) is a mixture of acrylic acid and methacrylic acid and a) (ii) is ammonium allylpolyethoxy (10) sulphate.

15. The building material composition of claim 1, wherein a) (i) is a mixture of acrylic acid and 2-acrylamido-2-methylpropane sulfonic acid.

16. The building material composition of claim 11, wherein a) (ii) is allylpolyethoxy (10) phosphate.

17. The building material composition of claim 1, wherein a) (i) is methacrylic acid and a) (ii) is ammonium allylpolyethoxy (10) sulphate.

18. A building material composition comprising
(a) a water-soluble or water dispersible polymer of the formula: 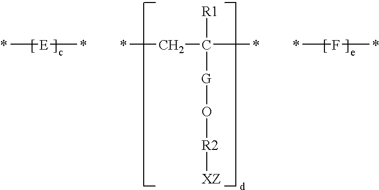
wherein E is the repeating unit remaining after polymerization of an ethylenically unsaturated compound; R₁ is H or lower (C₁-C₄) alkyl; G is —CH₂— or —CHCH₃—; R₂ is
(CH₂—CH₂—O)ₙ or (CH₂—CHCH₃—O)ₙ;
wherein n ranges from about 1 to 100; X is SO₃, PO₃ or COO; Z is H, or a water soluble cationic moiety; F is a repeating unit of the formula: 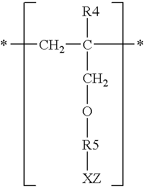
wherein R₄ is H or lower (C₁-C₄) alkyl, R₅ is hydroxy substituted alkyl or alkylene having from 1 to 6 carbon atoms; c and d are positive integers; and e is a non-negative integer, and
(b) a binding material comprised of cement or gypsum.

19. The building material composition of claim 18, wherein said ethylenically unsaturated compound is one or more of members selected from the group consisting of carboxylic acid, sulfonic acid, phosphonic acid, amide form thereof, and mixtures thereof.

20. The building material of claim 19, wherein said ethylenically unsaturated compound is one or more of members selected from the group consisting of acrylic acid, methacrylic acid, acrylamide, methacrylamide, N-methyl acrylamide, N, N-dimethyl acrylamide, N-isopropyl acrylamide, maleic acid or anhydride, fumaric acid, itaconic acid, styrene sulfonic acid, vinyl sulfonic acid, isopropenyl phosphonic acid, vinyl phosphonic acid, vinylidene diphosphonic acid, 2-acrylamido-2-methylpropane sulfonic acid and mixtures thereof.

21. The building material composition of claim 18, wherein said water-soluble cationic moiety is selected from the group consisting of Na, K, Ca and NH₄.

22. The building material composition of claim 18, wherein the weight average molecular weight (Mw) ranges from 1,000-1,000,000.

23. The building material composition of claim 18, wherein the weight average molecular weight (Mw) ranges from about 1,000 to about 50,000.

24. The building material composition of claim 18, wherein the weight average molecular weight (Mw) ranges from about 1,500 to 25,000.

25. The building material composition of claim 18, wherein the ratio c:d:e ranges from about 20:10:1 to 1:1:20.

26. The building material composition of claim 18, wherein e is zero and the ration c:d ranges from about 30:1 to about 1:20.

27. The building material composition of claim 18, wherein n ranges from about 1 to 20.

28. The building material composition of claim 18, wherein the cement is selected from the group consisting of concrete, tile cements and adhesives, projection plasters, stuccos based on cement and synthetic binders, ready mixed mortars, manually applied mortars, underwater concrete, joint cement, crack fillers, floor screeds, and adhesive mortars.

29. The building material composition of claim 18, wherein the gypsum is plaster of Paris.

30. A building material composition comprising (a) a water-soluble or water dispersible polymer of the formula: 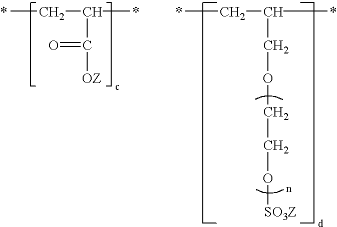
wherein n ranges from about 1-100, Z is hydrogen or a water-soluble cation, and (b) a binding material of cement or gypsum.

31. The building material composition of claim 30, wherein said water soluble cation is selected form the group consisting of Na, K, Ca, NH₄, and mixtures thereof.

32. The building material composition of claim 30, wherein the ratio c:d ranges from about 30:1 to about 1:20.

33. The building material composition of claim 30, wherein the molecular weight Mw ranges from about 1,000 to 1,000,000.

34. The building material composition of claim 30, wherein the molecular weight Mw ranges from about 1,000 to 50,000.

35. The building material composition of claim 30, wherein the molecular weight Mw ranges from about 1,000 to 25,000.

36. The building material composition of claim 30, wherein n ranges from about 1 to 20.

37. The building material composition of claim 30, wherein the cement is selected from the group consisting of concrete, tile cements and adhesives, projection plasters, stuccos based on cement and synthetic binders, ready mixed mortars, manually applied mortars, underwater concrete, joint cement, crack fillers, floor screeds, and adhesive mortars.

38. The building material composition of claim 30, wherein the gypsum is plaster of Paris.

39. A building material composition comprising (a) a water-soluble or water dispersible polymer of the formula 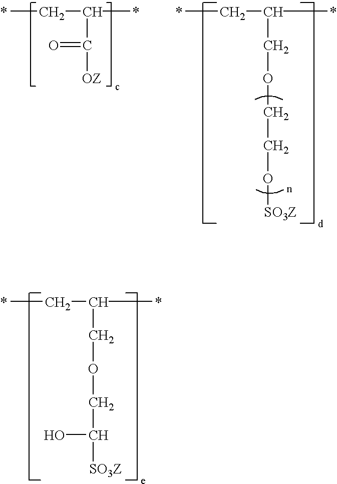
wherein n ranges from about 1-100, and z is hydrogen or a water-soluble cation, and (b) a binding material of cement or gypsum.

40. The building material composition of claim 39, wherein said water soluable cation is selected from the group consisting of Na, K, Ca, NH₄, and mixtures thereof.

41. The building material composition of claim 39, wherein the ration c:d:e ranges from about 20:10:1 to about 1:1:20.

42. The building material composition of claim 39, wherein the molecular weight Mw ranges from about 1,000 to 1,000,000.

43. The building material composition of claim 39, wherein the molecular weight Mw ranges from about 1,000 to 50,000.

44. The building material composition of claim 39, wherein the molecular weight Mw ranges from about 1,000 to 25,000.

45. The building material composition of claim 39, wherein n ranges from about 1 to 20.

46. The building material composition of claim 39, wherein the cement is selected from the group consisting of concrete, tile cements and adhesives, projection plasters, stuccos based on cement and synthetic binders, ready mixed mortars, manually applied mortars, underwater concrete, joint cement, crack fillers, floor screeds, and adhesive mortars.

47. The building material composition of claim 39, wherein the gypsum is plaster of Paris.
